(19) United States
(12) Patent Application Publication
(10) Pub. No.: US 2021/0025777 A1
(43) Pub. Date: Jan. 28, 2021

(54) METHOD FOR PRODUCING A CORROSION-RESISTANT ASSEMBLY OF A FIELD DEVICE

(71) Applicant: Endress+Hauser SE+Co. KG, Maulburg (DE)

(72) Inventors: Sergej Lopatin, Lörrach (DE); Peter Klöfer, Steinen (DE)

(21) Appl. No.: 16/630,224

(22) PCT Filed: Jul. 9, 2018
(86) PCT No.: PCT/EP2018/068466

§ 371 Date: Jan. 10, 2020

(30) Foreign Application Priority Data
Jul. 12, 2017 (DE) 10 2017 115 651.8

(51) Int. Cl. G01L 19/06; B33Y 80/00; B22F 3/105; B33Y 10/00; G01L 9/00; B23K 26/342; B23K 26/00; G01D 11/26

(52) U.S. Cl. CPC G01L 19/0645; B33Y 80/00; B22F 3/1055; G01D 11/26; G01L 9/0041; B23K 26/342; B23K 26/0006; B33Y 10/00

(57) ABSTRACT

The invention relates to a method for producing a corrosion resistant assembly of a field device for determining or monitoring a physical or chemical process variable of a medium in an automated plant and to a corresponding assembly, wherein the assembly is composed of at least a first component and a second component, wherein the components are connected with one another in a connection region, wherein the first component is composed at least in the connection region of a corrodible material and wherein the second component is composed at least in the connection region of corrosion resistant material or of a corrodible material.

The invention relates to a method for producing a corrosion-resistant assembly of a field device for determining or monitoring a physical or chemical, process variable of a medium in an automated plant, wherein the assembly is composed of at least a first component and a second component, wherein the components are connected with one another in a connection region, wherein the first component is composed at least in the connection region of a non-corrosion resistant (i.e., corrodible) material and wherein the second component is composed at least in the connection region of a corrosion resistant material or of a corrodible material.

In automated plants, especially in process automation plants, field devices are often applied, which serve for registering and/or influencing process variables. Serving for registering process variables are sensors, which, for example, are integrated into fill level measuring devices, flowmeters, pressure and temperature measuring devices, pH-redox potential measuring devices, conductivity measuring devices, etc., which register the corresponding process variables, fill level, flow, pressure, temperature, pH value, and conductivity. Serving for influencing process variables are actuators, such as, for example, valves or pumps, via which the flow of a liquid in a pipe, tube or pipeline section, or the fill level in a container can be changed. Referred to as field devices are, in principle, all devices, which are applied near to the process and which deliver, or process, process relevant information. In connection with the invention, the terminology, field devices, thus, refers also to remote I/Os, radio adapters, and, in general, devices, which are arranged at the field level. A large number of such field devices are produced and sold by the firm, Endress+Hauser.

An important goal of measurement and/or automation technology is so to embody field device components, which are exposed to an aggressive measured medium and/or an aggressive atmosphere in a process, that they are reliably protected against corrosion. To be emphasized in this connection is especially protecting corrosion susceptible sensor elements. A concrete example is a diaphragm seal. A diaphragm seal comprises a flange and a thin metal membrane, which is secured to the flange. By means of the membrane, a process pressure is transferred via an inert pressure transfer liquid to a measurement cell. If the diaphragm seal is applied for pressure measurement in an aggressive measured medium, then both the membrane as well as also the flange must, at least to the extent that they are exposed to the measured medium, be made of corrosion resistant material. Suitable materials are preferably noble, and therewith expensive, metals, such as, e.g., gold, platinum, tantalum, titanium, zirconium and nickel, however, also alloys, such as, for example, chemically resistant Hastelloy® and copper alloys. A suitable copper alloy is known, e.g., under the designation, Monel®. Because these corrosion resistant materials are expensive, the sensor elements are usually not made of corrosion resistant material, but, instead, often of a stainless steel, which is provided with an appropriate corrosion resistant, protective cover coating or plating.

For applying a protective cover coating, various methods can be applied:
Thus, in the case of plating methods, e.g., a flange of a corrodible material is covered with a Hastelloy® layer on the process side. By a plating—same as with the following mentioned coating methods—the material costs can be significantly reduced. An advantage of plating a corrodible material with a corrosion resistant material is especially that it can be used for all corrosion resistant materials, especially also for all alloys.
The components to be protected against corrosion cover can be coated with a noble metal via a galvanic coating method. The method functions quite well with gold, platinum, silver and pure nickel. However, alloys, such as e.g. Monel® or Hastelloy®, cannot be deposited from electrolytes. Tantalum, titanium and zirconium can only be galvanically deposited from a molten salt at very high temperatures. Of course, this last method is not practical for galvanic coating of sensitive, especially temperature sensitive, sensor components.
Coating methods in various forms are known and are referred to via the following abbreviations: ALD (atomic layer deposition), CVD (chemical vapor deposition) and PVD (physical vapor deposition). Coating processes are performed in vacuum. The coatings produced via these methods have a character similar to the coatings produced by means of galvanic deposition. The sputter methods, which are PVD methods, are suitable for all metals and most alloys. Its disadvantage is that sputtering processes are complex and slow. As a result, their production costs are relatively high. Of course, sputtering is only a special method out of a large number of known coating methods. The sputtering (atomizing), which is also known as cathode sputtering, is a physical procedure, in the case of which atoms transfer from a solid body (target) into the gas phase by bombardment with energetic ions (predominantly inert gas ions).
In the case of hard soldering, or brazing, of a foil of a chemically resistant material, such is soldered spread out, e.g., on a flange. Used as solder can be a solder foil of silver-based or nickel-based material. At the melting temperature, the solder wets the surface region of the component to be provided with the protective cover, so that the foil is secured to the surface of the component after cooling. Preferably used as foil material is tantalum, titanium, Monel®, Hastelloy®, nickel, stainless steel, etc.

The coating methods known from the state of the art have advantages and disadvantages. Especially critical is the manufacture of coatings of tantalum, niobium, titanium or zirconium. For reasons of cost, a galvanic coating process for these metals is excluded. The coating methods ALD, CVD and PVD are too complex and expensive for producing field devices. The soldering process has the large disadvantage that the metals, tantalum, niobium, titanium and zirconium, preferred for coating foils have coefficients of thermal expansion, which differ greatly from the coefficient of thermal expansion of, e.g., stainless steel. Since the soldering takes place at high temperatures, the thin foils are greatly strained and deformed after the soldering and cooling. A resistant coating is thus not assured.

An object of the invention is to provide method and assemblies characterized by corrosion resistance produced in simple and reliable manner.

The object is achieved by a method comprising method steps as follows:
on at least a portion of the first component, which includes a connection region, a coating of corrosion resistant material is applied directly or via at least one functional intermediate layer by a generative manufacturing method, wherein the coating has a predetermined thickness profile;
for the case in which the second component is composed of a corrodible material, on at least a portion of the second component, which includes the connection region, a coating of corrosion resistant material is applied directly or via at least one functional intermediate layer by a generative manufacturing method, wherein the coating has a predetermined thickness profile;
the two components are connected with one another in the connection region via a welding method, wherein due to the predetermined thickness profile/the predetermined thickness profiles of the corrosion resistant coating/coatings, a welding of the first component and the second component occurs essentially between the two corrosion resistant coatings, i.e., between the corrosion resistant coating of the first component and the corrosion resistant material of the second component.

The corrosion resistant material is preferably gold, platinum, tantalum, zirconium, nickel or Hastelloy® or a chemically resistant copper alloy, such as e.g., Monel®. As already mentioned, a wide variety of corrosion resistant materials can be applied as coating on a corrodible component via a laser sintering method.

Preferably for applying the predetermined thickness profile, or the predetermined thickness profiles, of the corrosion resistant coating/coatings and/or, in given cases, for applying the functional intermediate layer/layers, a 3D printing method, especially a selective laser sintering method, is used. Selective laser sintering (SLS) is a generative manufacturing method, in the case of which 3-dimensional structures are produced by sintering of a powdered starting material with a laser. Selective laser sintering is suitable for processes, in the case of which plastic or metal powder is melted layer upon layer completely and without application of binders. After the solidification of the molten material, or processing of all layers, a homogeneous material of high density is obtained.

Advantages of the 3D printing method, and here especially laser sintering, are as follows:
It is a cost effective manufacturing method, which is significantly simpler to perform as compared with soldering or CVD coating.
Since in the case of 3D printing, and here in the case of laser welding, little heat arises, especially sensitive components are neither deformed nor distorted by the welding process.
Via a 3D printing method, a corrodible component can be coated and durably bonded with corrosion resistant material of any layer thickness. Because of the suitable thickness of the at least one coating especially in the connection region of the two components, it is assured that the welded connection is free of any corrodible material. It can be effectively avoided that fractions of the corrodible material get mixed into the welded connection.

According to the invention, a coating of corrosion resistant, or non-corroding, material is applied on at least one surface-portion of the corrodible component. An option is, however, also the applying of two or more layers, or coatings. For example, a component of a corrodible material is in a first method step precoated with a first metal; then a layer of a second metal is applied. In such case, e.g., the intermediate layer assumes the function of a bonding aid to provide an improved bonding of the corrosion resistant material of the protective layer on the component to be protected.

Additionally or alternatively, the functional intermediate layer of the first metal can serve for an optimized coupling between the corrosion resistant protective cover layer and the corrodible component in the case in which the two materials possess very different coefficients of thermal expansion. This is illustrated based on the following example: a corrodible stainless steel 1.4435 (316L) has a coefficient of thermal expansion of about 17×10\hat{ }−6 1/K, while corrosion resistant tantalum has a coefficient of thermal expansion of (7−8)×10\hat{ }−6 1/K. A functional intermediate layer of Hastelloy C22 with an intermediately lying coefficient of thermal expansion of (12−13)×10\hat{ }−6 1/K can significantly reduce thermal stresses arising in the tantalum layer in the case of a temperature change, so that the corrosion resistant coating remains durably bonded with the component.

In an advantageous, further development of the method of the invention, the coating/coatings or the functional intermediate layer on the first component and/or the second component are/is applied with an essentially homogeneous thickness; and, in such case, the predetermined thickness profile, or the predetermined thickness profiles, of the coating/coatings and/or, in given cases, the at least one functional intermediate layer are/is implemented via a grinding process using a grinder or a turning process using a lathe.

Preferably, a laser welding method is used as welding method.

The object is achieved, furthermore, by an assembly for determining and/or monitoring a physical or chemical, process variable of a medium in an automated plant, wherein the assembly is composed at least of a first component and a second component, wherein the components are welded together in a connection region, and wherein at least one of the two components is composed of a corrodible material, wherein the assembly is produced via at least one of the above described methods.

For example, the assembly is a diaphragm seal for determining and/or monitoring pressure of a medium, wherein the two components of the diaphragm seal to be welded together are a flange of a corrodible material and a measuring membrane of corrosion resistant material. Provided between the flange and the measuring membrane is a chamber for accommodating a pressure transfer liquid. Via the bond between the corrosion resistant coating on the flange and the measuring membrane of corrosion resistant material, the chamber is durably sealed from the measured medium.

Preferably, the coating on the flange, on the one hand, and the measuring membrane, on the other hand, are of the same corrosion resistant material, wherein the material is preferably tantalum. The flange is preferably manufactured of stainless steel.

Preferably, the thickness of the coating in the connection region is in the range, 0.1-5.0 mm, preferably 0.1-0.5 mm. As already stated above, the method of the invention is implementable for any thickness of the coating/coatings. The thickness of the coating/coatings is, however, for reasons of cost so selected that it always lies within a range as here specified and the connection region after the welding process is free of a mixing of corrodible material into the corrosion resistant material.

The thickness of the measuring membrane lies, moreover, preferably in the range, 0.025-0.2 mm.

As further example of an assembly, which can be used in an automated plant and which is produced via the method of the invention, is provided by a vibronic sensor for determining fill level, density and/or viscosity of a medium, wherein the medium is located in a container. The two components of the vibronic sensor to be welded together are a flange of a corrodible material and a sensor element of corrosion resistant material. The sensor element comprises a pot-shaped housing, which is sealed with a membrane on an end region facing the medium. Formed on the membrane is, in given cases, at least one oscillatory tine. Provided in the connection region and also in the flange areas, which come in contact with the measured medium or with the atmosphere in the container, is a corrosion resistant coating. The two components—flange and sensor element—are welded together in the connection region, wherein, in turn, by a correspondingly predetermined thickness of the coating, it is assured that during the welding process only corrosion resistant materials of coating and sensor element are connected with one another. A mixing in of corrodible material in the connection region can, in this way, be effectively prevented.

Preferably, the sensor element is composed of stainless steel, and also the corrosion resistant coating on the flange is a coating of stainless steel.

The invention will now be explained in greater detail based on the appended drawing. The figures of the drawing are all sectional views and show as follows:

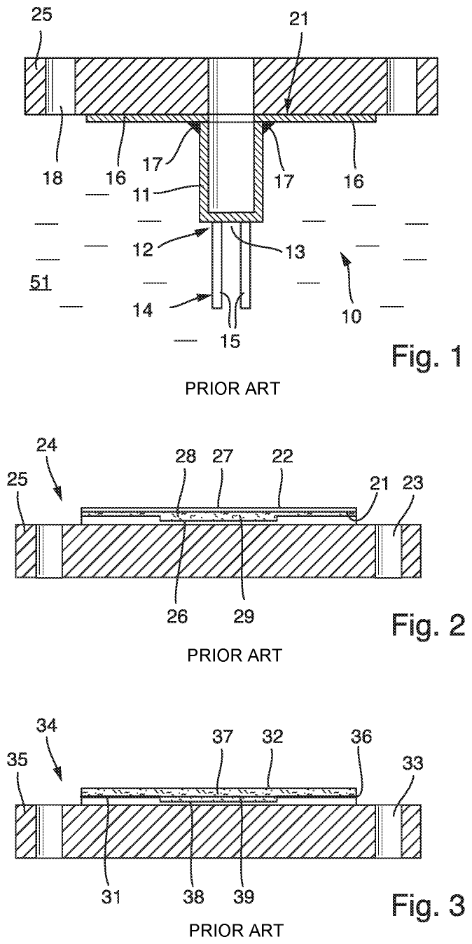

FIG. 1 a solution known from the state of the art for a vibronic sensor element, in the case of which the protective cover layer for the component to be protected against corrosion was applied via a plating method,

FIG. 2 a solution for a diaphragm seal known from the state of the art, in the case of which the protective cover layer for the component to be protected against corrosion was applied via a galvanic coating method,

FIG. 3 a solution for a diaphragm seal known from the state of the art, in the case of which the protective cover layer for the component to be protected against corrosion was applied via a hard soldering, or brazing, method,

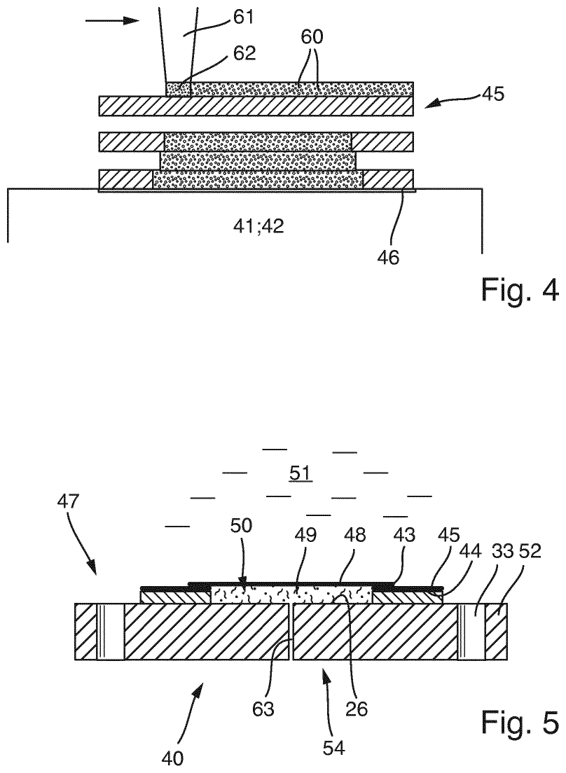

FIG. 4 a schematic view, which illustrates the local sintering/melting of metal particles of the invention in the case of a selective laser sintering method (SLS),

FIG. 5 a schematic view of an assembly of a diaphragm seal, which was produced according to the method of the invention, and

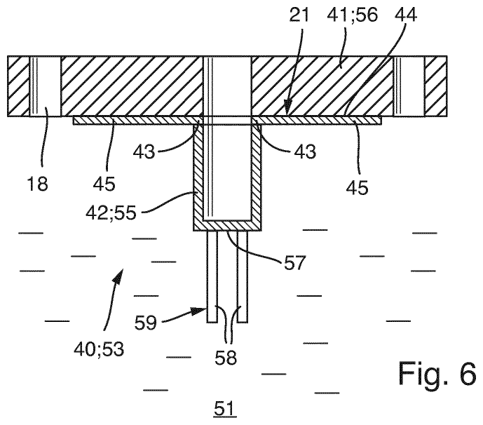

FIG. 6 a schematic view of an assembly of a vibronic sensor, which was produced according to the method of the invention.

Illustrated in FIGS. 1-3 are sections of assemblies, which are protected against corrosion via coating methods known from the state of the art.

FIG. 1 shows a solution known from the state of the art for protecting a vibronic sensor element 10 against corrosion by a medium 51 or by a corrosive atmosphere in a container, in which the medium 51 is arranged. For reasons of cost, the flange 25 is composed of a corrodible material, e.g., stainless steel. Flange 25 is coated via a plating method on the process side in the region of the area 21 to be sealed with a layer of corrosion resistant material, e.g., Hastelloy®. The bores 18 in the flange 25 serve for securing the vibronic sensor element 10 on a process flange (not shown).

The other components of the sensor element 10, especially the sensor pot 11, or the pot-shaped housing 11, and the oscillatable unit 12 composed of the membrane 13 on the process facing end region of the sensor pot 11 and the oscillatory fork 13 with two tines 14—thus, all components, which come in contact with the medium or the atmosphere in the container—are manufactured of corrosion resistant material. Such material is often Hastelloy®. Furthermore, a welded connection 17 between the corrosion resistant material of the plated layer 16 on the flange 25 and the corrosion resistant material of the sensor pot 12 can be provided. Of course, the plated layer 16 does not necessarily have to be welded with the flange 25. Because of the plated layer 16, which best serves as a suitable sealing surface, the flange 25 same as, in given cases, the connection region 17 between the flange 25 and the sensor pot 11 are protected against corrosion.

FIG. 2 shows a solution known from the state of the art for corrosion endangered components 24 of a diaphragm seal, in the case of which the solder layer 22 is applied on the sealing surface 21 of a flange 25. Flange 25 and membrane 27 are manufactured of the same material. The solder layer 22 is located also between the sensor bed 26 and the membrane 27. Sensor bed 26 and membrane 27 form a chamber 28 for accommodating a pressure transfer medium 29. The disadvantages of this solution have been described above.

FIG. 3 shows a solution known from the state of the art, in the case of which the components 34 of a diaphragm seal 37 to be protected against corrosion are protected by means of a corrosion resistant membrane 32. The corrosion resistant membrane 32 is connected via solder 36 and a hard soldering or brazing method and is spread on the area 31 to be sealed. Sensor bed 38 and corrosion resistant membrane 32 form a chamber 37 for accommodating pressure transfer medium 39. Also this solution has disadvantages, which have already been described above.

FIG. 4 shows a schematic view, which especially illustrates the local sintering/melting of metal particles 60 applied in the case of the method of the invention by means of a laser beam 61. According to the invention, the construction of corrosion resistant coating 45 occurs preferably by means of a selective laser sinter method (SLS). SLS is a generative, layer build-up method, with which the corrosion resistant coating 45 of the invention of a metal or an alloy in any layer thickness, or with any thickness profile, is applied on a portion 44 of a component 41; 42 to be protected against corrosion. An advantage of the layer build-up method of the invention is especially that, by the successive, however, local, melting of the metal particles 60, mechanical stresses, which occur during the following cooling process in the corrosion resistant coating 45, are lower than in the case of the solder or welding methods, which act on a greater area and which are used in the state of the art for applying a coating 45 on a component 41, 42.

In the visualized case, a functional intermediate layer 46 is located between the component 41; 42 and the coating 45. The functional intermediate layer 46 acts, for example, as a bonding aid and enables a lasting connection between the material of the component 41, 42 and the material of the coating 45. Via a suitable choice of the material of the functional intermediate layer 46, also, e.g., a suitable buffering between different coefficients of expansion of the material of the component 41; 42 and the coating 45 can be achieved.

In FIG. 4, the granularly shaded regions show unsintered metal particles 60, while the continuously represented regions show the individual layers of the corrosion resistant protective cover layer 45 produced in the layer build up method. The arrow shows the current direction of movement of the laser beam 61.

FIG. 5 shows a schematic view of the corrosion resistant assembly 40 of a diaphragm seal 47 produced according to the method of the invention. Especially, the assembly 40 is a so-called flange assembly. The flange 52 of the flange assembly 40 is—for reasons of cost—produced from a corrodible material. Flange 52 is coated, e.g., via a 3D printing method, especially via an SLS method, in the portion 44 (which can also be referred to as the area 21; 31 to be sealed) with corrosion resistant material. The coating 45 has a predetermined thickness and/or a predetermined thickness profile. Alternatively, it is also possible to apply the coating 45 with a predetermined thickness via a 3D printing method and then to bring it via mechanical material removal methods (grinding, machining, etc.) to the desired thickness and/or the desired thickness profile. Likewise, the surface of the coating 45 can be provided e.g. with a desired roughness by subsequent mechanical processing.

Applied on the coating 45 is the measuring membrane 48 of corrosion resistant material. The two components 41, 42; 45, 48 are preferably welded together in the connection region 43. Especially a laser welding method is applied for this. Located between the measuring membrane 48 and the sensor bed 26 is a chamber 49. Such is, same as the connecting line 63, filled with pressure transfer liquid 50. The bores 33 in the flange 52 serve for securing the flange assembly 40 on a process flange (not shown).

The following example serves for purposes of illustration. Of course, instead of the corrosion resistant material, tantalum, also other corrosion resistant materials can be used. The same holds for the material of the corrodible component(s). Likewise the numerical values are examples.

The coating 45 applied in the 3D printing method on the flange 52 can be as thick as desired, e.g., 0.1-5.0 mm. For many applications, however, a tantalum layer of 0.1-0.5 mm is sufficient completely to avoid corrosion of the component 41; 42 to be protected. The membrane 48 is, e.g., a tantalum foil, which is welded on the coating 45 in the connection region 43, e.g., by laser welding. Tantalum foils can have, for example, a thickness of 0.025 to 0.200 mm. Preferably, the thickness of the tantalum foil is, e.g., 0.10 mm when the coating 45 has a thickness of, e.g., 0.20 mm.

FIG. 6 is a schematic view of the assembly 40; 53 of a vibronic sensor for determining the fill level, the density and/or the viscosity of a medium 51, wherein the assembly 40; 53 has been produced according to the method of the invention. The two components 41, 42 of the vibronic sensor 53 to be connected, e.g., to be welded together, are a flange 56 of a corrodible material and a sensor element 59 of corrosion resistant material. Sensor element 59 comprises a pot-shaped housing 55, which is sealed on its end region facing the medium 51, thus, on the process side, with a membrane 57. Formed on the membrane 57 is, in given cases, at least one oscillatory tine 58, although vibronic sensors in the form of so-called membrane oscillators are also known.

Flange 56 is provided with corrosion resistant coating 45 in the region, which can—directly or indirectly—come in contact with a medium 51. The thickness of the coating 45 applied via a 3D printing method is, in such case, so selected and/or structured that in a following joining process, e.g., a welding, of the two components 55, 56 only the corrosion resistant material, or the corrosion resistant materials, are melted and connected with one another. A mixing in of corrodible material into the joined connection region 43 of the two components 41, 42; 55, 56 of the assembly 40 is, thus, safely excluded.

In summary, advantages of the solution of the invention include the following:
Since the laser welding produces little heat, e.g., an foil-like measuring membrane 48 of a pressure sensor is neither deformed nor distorted after the joining process, especially a welding process. Without problem—easily and safely—also a forming of the measuring membrane 48, e.g., with a stamp, can be performed.
The coating 45 of a component, e.g., a flange 52, with corrosion resistant material, e.g., tantalum, by means of a 3D printing method enables the construction of any layer thickness. It is possible in the case of a diaphragm seal 47 to weld a relatively thin foil (measuring membrane 48) of corrosion resistant metal, e.g., tantalum, directly on the corrosion resistant coating 45 of the component 52, without that the welding melts the underlying material of the component 52, which is not corrosion resistant, and which would then get mixed in the connection region 43 (weld region) into the corrosion resistant material of the coating 45. In the case of a vibronic sensor 53, the connection between the coating 45 applied on the flange 56 and the end region of the sensor pot 55 occurs far from the medium 51, wherein both the coating 45 as well as also the sensor pot 55 are usually produced of corrosion resistant material. If the latter is not the case, then also here a coating 45 of a suitable thickness, with a suitable thickness profile, can be applied by 3D printing method.
The 3D printing method, especially the SLS method, is a very favorable production method, which is significantly simpler to implement than soldering or CVD coating.

### LIST OF REFERENCE CHARACTERS

10 components of the sensor element of a vibronic sensor
11 sensor pot, or tubular housing
12 oscillatable unit
13 membrane
14 tuning fork
15 tines
16 plated layer
17 welded connection
18 bore
21 area to be sealed
22 corrosion resistant coating
23 bore
24 components of the sensor element of a diaphragm seal
25 flange
26 sensor bed
27 membrane
28 chamber
29 pressure transfer medium
31 area to be sealed
32 corrosion resistant membrane
33 bore
34 components of the sensor element of a diaphragm seal
35 flange
36 solder
37 chamber
38 sensor bed
39 pressure transfer medium
40 corrosion resistant assembly
41 first component
42 second component
43 connection region
44 portion
45 coating
46 functional intermediate layer
47 diaphragm seal
48 measuring membrane
49 chamber
50 pressure transfer liquid
51 medium
52 flange
53 assembly of the vibronic sensor
54 sensor element diaphragm seal
55 pot-shaped housing/sensor pot
56 flange
57 membrane
58 oscillatory tine
59 sensor element of the vibronic sensor
60 metal particles
61 laser beam
62 sintered metal particles
63 connecting duct

1-13. (canceled)

14. A method for manufacturing a corrosion resistant assembly of a field device for determining or monitoring a physical or chemical process variable of a medium in an automated plant, wherein the assembly comprises at least a first component and a second component, wherein the first component includes, at least in a first connection region, a corrodible material, and wherein the second component includes, at least in a second connection region, a corrosion resistant material or a corrodible material, the method comprising:
applying a first coating of a corrosion resistant material on at least a portion of the first component in the first connection region, directly or via a first functional intermediate layer, using a generative manufacturing method such that the first coating has a first thickness profile;
when the second component includes, at least in the second connection region, a corrodible material, applying a second coating of a corrosion resistant material on at least a portion of the second component in the second connection region, directly or via a second functional intermediate layer, using a generative manufacturing method such that the second coating has a second thickness profile;
when the second component includes, at least in the second connection region, a corrosion resistant material, connecting the first component and second component to each other in the first and second connection regions, respectively, via a welding method, wherein, due to the first thickness profile, a weld is formed essentially between the first coating of the first component and the second component; or
when the second component includes, at least in the second connection region, a corrodible material, connecting the first component and second component to each other in the first and second connection regions, respectively, via a welding method, wherein, due to the first thickness profile and second thickness profile, a weld is formed essentially between the first coating of the first component and the second coating of the second component.

15. The method of claim 14, wherein a three-dimensional printing method is used to apply the first coating with the first thickness profile and/or the first functional intermediate layer, and
wherein, when the second component includes a corrodible material at least in the second connection region, the three-dimensional printing method is used to apply the second coating with the second thickness profile and/or the second functional intermediate layer.

16. The method of claim 15, wherein the three-dimensional printing method is a selective laser sintering method.

17. The method of claim 14, wherein the first coating, the first functional intermediate layer, the second coating and/or the second functional intermediate layer are applied with an essentially homogeneous thickness, and
wherein the first thickness profile and/or the second thickness profile are formed via a grinding or turning process, and/or
wherein thickness profiles of the first and second functional intermediate are formed via a grinding or turning process.

18. The method of claim 14, wherein the welding method is a laser welding method.

19. The subassembly of claim 14, wherein the corrosion resistant material of the first coating and/or second coating is gold, platinum, tantalum, zirconium, nickel, Hastelloy® or a chemically resistant copper alloy.

20. A subassembly of a field device configured for determining or monitoring a physical or chemical process variable of a medium in an automated plant, the assembly comprising:
the first component having the first connection region; and
the second component having the second connection region,
wherein the first component and the second component are welded together in the first and second connection regions, respectively,
wherein at least one of the first and second components is composed of a corrodible material at least in the first or second connection regions, respectively, and
wherein the assembly is manufactured by the method of claim 14.

21. The subassembly of claim 20, wherein the subassembly is a diaphragm seal of a sensor element adapted for determining and/or monitoring pressure of the medium,
wherein the first component of the diaphragm seal is a flange of a corrodible material and is configured to be attached to a process flange,
wherein the second component of the diaphragm seal is a measuring membrane of a corrosion resistant material, and
wherein the flange and the measuring membrane are connected to each other such that a chamber is formed in the sensor element, the chamber filled with a pressure transfer liquid and sealed from the medium.

22. The subassembly of claim 21, wherein the first coating on the flange and the second coating on the measuring membrane are produced from the same corrosion resistant material, wherein the corrosion resistant material is tantalum, Monel® or nickel alloy.

23. The subassembly of claim 21, wherein the flange is stainless steel.

24. The subassembly of claim 20, wherein the first thickness profile in the first connection region and the second thickness profile in the second connection region is between 0.1 and 5 mm.

25. The subassembly of claim 20, wherein the first thickness profile in the first connection region and the second thickness profile in the second connection region is between 0.1 and 0.5 mm.

26. The subassembly of claim 20, wherein the measuring membrane has a thickness in a range from 0.025 to 0.2 mm.

27. The subassembly of claim 20, wherein the subassembly is a vibronic sensor configured to determine a fill level, density and/or viscosity of the medium,
wherein the first component of the vibronic sensor is a flange of a corrodible material and is configured to be attached to a process flange,
wherein the second component of the vibronic sensor is a sensor element of a corrosion resistant material, wherein the sensor element includes a pot-shaped housing that is sealed with a membrane on an end region facing the medium, wherein membrane includes at least one oscillatory tine.

28. The subassembly of claim 27, wherein the sensor element is manufactured of stainless steel and wherein the first coating on the flange is a coating of stainless steel.

29. The subassembly of claim 20, wherein the corrosion resistant material of the first coating and/or second coating is gold, platinum, tantalum, zirconium, nickel, Hastelloy® or a chemically resistant copper alloy.
